(19) United States
(12) Patent Application Publication
(10) Pub. No.: US 2011/0005865 A1
(43) Pub. Date: Jan. 13, 2011

(54) APPARATUS FOR CONTROLLED DESCENT FROM AN ELEVATED LOCATION

(76) Inventors: Alon Tavori, Haifa (IL); Ephraim Vadai, Nes Ziona (IL); Gideon Hirschfeld, Ein Harod Meuhad (IL)

Correspondence Address: Pearl Cohen Zedek Latzer, LLP, 1500 Broadway, 12th Floor, New York, NY, 10036, US

(21) Appl. No.: 12/922,429

(22) PCT Filed: Mar. 25, 2009
(86) PCT No.: PCT/IL09/00329

§ 371 Date: Sep. 13, 2010

(30) Foreign Application Priority Data
Mar. 30, 2008 (IL) 190512

(51) Int. Cl. A62B 1/08

(52) U.S. Cl. 182/231

(57) ABSTRACT

An apparatus for facilitating a controlled descent of a body is disclosed. The apparatus includes a rotatable reel around which a portion of a cable is wound, a first end of the cable secured to the reel and a second end of the cable free; a friction drum around which a portion of the cable, is wound; a carrier on which the reel and the drum are mounted, a braking mechanism for braking rotational motion of the reel and for balancing descending speed of the body; a harness, for harnessing the device to the body; and a damping mechanism for damping the initial impact.

### FIELD OF THE INVENTION

The present invention relates to a self-braking safety apparatus with shock-absorbing mechanisms and an easy-to-use adjustable body harness, adapted to permit rapid descent of persons from tall buildings or other elevated places in cases of emergency. More particularly it relates to an apparatus for facilitating a controlled descent of a body from an elevated location.

### BACKGROUND OF THE INVENTION

It may be necessary to evacuate upper floors of buildings or other high-elevations without having access to normal routes of egress. While fire is the most common case there are many others possible events that render building structures in danger of imminent collapse, such as earthquakes or construction failures that result in extensive damage and the blocking of the regular entrance and exit routes.

As a result of recent acts of urban terrorism and of skyscraper fire tragedies there is an increase in public awareness for the necessity of dependable and safe devices for rapid escape in the event of danger in high rise structures.

The preferred way out of an extensively damaged or life-endangering tall building usually dictates the descent of entrapped people outside the walls of the building. A device that enables rapid, controlled descent of a person on the outside of a building can also be used in circumstances requiring rapid, safe descent from high places, such as cliffs, bridges, ships, or helicopters.

A number of prior art devices have been proposed such a winches, rappelling devices, and various shock absorber mechanisms. The devices suffer from various disadvantages, such as damage incurred from inadequate dissipation of heat generated from friction during descent; reliance on batteries, oil, other materials with limited shelf life and/or heavy weight or complex mechanisms that are costly to manufacture, maintain, and use; and fixed-point installation, which renders them useless if the emergency condition prevents people from reaching the device installation point.

For example, in U.S. Pat. No. 4,729,454 (Bareili et al.), there was disclosed a self-braking apparatus provided for cases of emergency in which a rapid descent of persons threatened by fire or danger is required on the outside of buildings or the like. The apparatus can be secured to a fixed point from which the descent is to be made and comprises a rotor on which a rope is wound which is mounted coaxially and inwardly of a drum. A heat-resistant handle and a brake, which can be actuated by the user are secured to the drum by brackets. The rotor is provided with a plurality of radial holes each containing a spring urging a brake pad outwardly against the inner surface of the drum. The brake, which can be actuated by the user, is formed by a pair of levers pivotally connected to each other and acting with one of their ends on rods having an inclined plane in turn acting on brake pads urged against the lateral surface of the drum by the rods. When the hand brake is released, the rotation of the rotor and centrifugal force generated thereby exert braking action against the inner surface of the drum to produce a constant speed of descent of about 2.5 m/sec.

In US 2001/0023793 (Okamura) there was disclosed an escape device for escaping from a building or other high area in an emergency comprises a worm gear mechanism driven by an electric motor and operatively coupled to a reel having a length of high tension line wound around it, arranged within a casing, and a belt connected to the casing for supporting a person's body. The worm gear mechanism rotates the reel, feeding out the line, and thereby lowering the user to a safe location below.

WO 2005/094181 (Gal and Tavori) disclosed a device for facilitating a controlled descent of a body, the device comprising a rotatable reel around which at least a portion of a cable is wound, a first end of the cable secured to the reel and a second end of the cable free; a friction drum mounted coaxially around the reel, the cable, upon leaving the reel wound at least partially around the drum; a carrier on which the reel and the drum are mounted; wherein the reel is provided with braking means for braking rotational motion of the reel and for balancing descending speed of the body.

An object of the present invention is the provision of an apparatus that is portable, lightweight, easy to store, requires no maintenance, is inexpensive to mass manufacture, dissipates heat efficiently and safely, is equipped with mechanisms that absorb the impact energy when coming to a halt after free falling, and has an easy to wear-and-adjust harness that can be used without special training by almost any person.

Other objects and advantages of the present invention will become apparent after reading the present specification and reviewing the accompanying drawings.

### SUMMARY OF THE INVENTION

There is thus provided, in accordance with some embodiments of the present invention, an apparatus for facilitating a controlled descent of a body, the apparatus comprising: a rotatable reel around which at least a portion of a cable is wound, a first end of the cable secured to the reel and a second end of the cable free; a friction drum mounted coaxially around the reel, the cable, upon leaving the reel wound at least partially around the drum; a carrier on which the reel and the drum are mounted; braking mechanism for braking rotational motion of the reel and for balancing descending speed of the body; a harness, for harnessing the device to the body and a damping mechanism for damping the initial impact.

Furthermore, in accordance with some embodiments of the present invention, the damping mechanism comprises at least one elastic spring element a first end of which is coupled to the carrier and a second end of which is coupled to the harness.

Furthermore, in accordance with some embodiments of the present invention, the damping mechanism comprises at least one elastic spring element that stretches on impact while emitting heat.

Furthermore, in accordance with some embodiments of the present invention, the damping mechanism comprises at least one fabric rip element made of a folded and tightly compacted fabric strip, a first end of which is coupled to the carrier and a second end of which is coupled to the harness.

Furthermore, in accordance with some embodiments of the present invention, the damping mechanism comprises at least one fabric rip element having stitches that rip and tear on impact.

Furthermore, in accordance with some embodiments of the present invention, wherein the damping mechanism comprises at least one fabric rip element having sections of the fabric strip glued together and at least some of the glued sections rip and tear on impact.

Furthermore, in accordance with some embodiments of the present invention, the harness of the apparatus for facilitating a controlled descent of a body is connected to the carrier in a breakable connection that breaks under initial impact inflicted on the body when beginning descent.

Furthermore, in accordance with some embodiments of the present invention, the breakable connection comprises break-bars.

Furthermore, in accordance with some embodiments of the present invention, the harness of the apparatus for facilitating a controlled descent of a body comprises straps firmly harnessing the body of the user of the apparatus.

Furthermore, in accordance with some embodiments of the present invention, the harness comprises a device for harnessing the body and a baby carrying device.

Furthermore, in accordance with some embodiments of the present invention, the apparatus for facilitating a controlled descent of a body is provided with a cable dispensing mechanism for dispensing a controlled length of the cable from the apparatus.

Furthermore, in accordance with some embodiments of the present invention, the dispensing mechanism comprises wheels operating in tandem which pull a portion of the cable from the drum while pushing another portion of the cable towards the drum, thus overcoming friction between the cable and the drum.

Furthermore, in accordance with some embodiments of the present invention, the cable dispensing mechanism comprises a ratchet mechanism.

Furthermore, in accordance with some embodiments of the present invention, the ratchet mechanism comprises a circular spring wheel and a cable reel wheel, having the rotational movement of the cable reel wheel controlled by the circular spring wheel.

Furthermore, in accordance with some embodiments of the present invention, the apparatus for facilitating a controlled descent of a body is encased in a portable encasing.

Furthermore, in accordance with some embodiments of the present invention, the encasing of the apparatus for facilitating a controlled descent of a body comprises an encasing box and a removable lid.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is an isometric illustration of an encased portable apparatus-for-controlled descent in accordance with an embodiment of the present invention, being removed from a shelf.

FIG. 2 is an isomeric illustration of an apparatus-for-controlled-descent in accordance with an embodiment of the present invention with its encasing opened and a heat-isolating-protruding-rim shown surrounding the carrier-plate of the apparatus. The apparatus includes a harness which is shown in FIG. 3.

FIG. 3 is an illustration of an apparatus-for-controlled-descent in accordance with an embodiment of the present invention shown, with a connected harness, in a ready to be worn state. Not shown is the Figure is the heat-isolation-protruding-rim illustrated in FIG. 2.

FIG. 4 is an illustration of the harness of apparatus-for-controlled-descent, shown in FIG. 3.

FIG. 5 is an isometric illustration of a person from the back, wearing the apparatus-for-controlled-descent shown in FIG. 3 and having the feet-straps of the harness hanging freely, ready to be worn.

FIG. 6 is an isometric illustration of a person from the back, wearing the apparatus-for-controlled-descent shown in FIG. 3 and getting into the feet-straps of the harness.

FIG. 7 is an isometric illustration of a person from the back, wearing the apparatus-for-controlled-descent shown in FIG. 3 in position, ready to fasten the harness belts.

FIG. 8 is an illustration from the front of a person wearing the apparatus-for-controlled-descent shown in FIG. 7 in position, after fastening the harness belts.

FIG. 9 is an illustration from the front of a person wearing the apparatus-for-controlled-descent shown in FIG. 8 having a baby carrying-device connected to the harness.

FIG. 10a is an illustration of a person wearing the apparatus-for-controlled-descent shown in FIG. 8, ready to pull the cable extension-handle and to pull out cable from the apparatus.

FIG. 10b is an illustration of a person wearing the apparatus-for-controlled-descent shown in FIG. 8, pulling the cable extension-handle and simultaneously pulling out cable from the apparatus.

FIG. 11 is an illustration of the carrier-plate of the apparatus-for-controlled-descent shown in FIG. 3, without the harness and with shock-absorbing springs in a relaxed state and the cable rolled.

FIG. 12 is an illustration of the carrier-plate of the apparatus-for-controlled-descent shown in FIG. 3, without the harness and with shock-absorbing springs in a stretched state and the cable drawn from the apparatus.

FIG. 13 is an illustration of on embodiment of the carrier-plate of the apparatus-for-controlled-descent without the harness and with shock-absorbing fabric-rip units (in place of shock absorbing springs, shown in FIG. 12) and the cable rolled.

FIG. 14 is an isomeric illustration of the mechanical assembly controlling the release of the cable in the apparatus-for-controlled-descent shown in FIG. 2 and FIG. 3.

FIG. 15 is side-view illustration of the mechanical assembly controlling the release of the cable in the apparatus-for-controlled-descent shown in FIG. 2 and FIG. 3.

FIG. 16 is a schematic side-view illustration of the ratchet mechanism of the mechanical assembly controlling the release of the cable in the apparatus-for-controlled-descent shown in FIG. 14

FIG. 17 is an isomeric illustration of the ratchet mechanism shown in FIG. 16.

### DETAILED DESCRIPTION OF PREFERRED EMBODIMENTS

The present invention provides a portable apparatus-for-controlled-descent of a person (or other body of mass) from a height by means of a cable wound onto a reel of the apparatus. According to an embodiment of the present invention, the user straps on the apparatus, attaches the free end of the cable to a solid fixed point, and lowers himself or herself out of a window or other egress-locations from which he or she can descend to a lower point. The most common anticipated use for the apparatus is for escaping from the height of a high building-floor down the outside of the building. In line with the anticipated use, for detailing the use and structure of the apparatus of the present invention from hereinafter reference will be made to descending from a building.

For the safety of people working, living or just visiting the high floors of tall buildings controlled descend apparatuses should be readily available and accessible at all times in readiness for emergencies. In accordance with an embodiment of the present invention, the controlled descend apparatus is packaged in a suitcase-like case that is esthetic to store in offices, stores and living quarters and is easy to carry and transport. In addition, the casing of the apparatus is simple to open and the device simple to use. In other embodiments of the present invention the apparatus-for-controlled-descent can be encased in other packaging arrangements.

When lowering out of a window or other egress points there is the imminent danger that a person using a descending-device will be harmed by the impact of the free-fall energy instantaneously released when the cable becomes fully tightened at the end of the initial drop from the point of exiting the building. In accordance with an embodiment of the present invention, the harmful free-fall impact-energy is minimized by three elements in apparatus:

In order not to release excess cable when positioning the cable to a solid fixed point, the apparatus has a manually controlled cable-releasing ratchet-mechanism. The fixing of the cable can be either to a pre-determined and constructed connection point or to a heavy and stable structural element such as a heavy piece of furniture. The mechanism minimizes the length of released cable, thus minimizing the available cable for free fall when starting the descent.

A damping mechanism in the apparatus absorbs most of the initial impact energy released at the end of the fall. The mechanism can be a spring-operated mechanism, a fabric-rip mechanism or other types of mechanisms. In a spring-operated mechanism the elastic springs are deformed on impact by the extreme stretching until the deformation stage of the material (such as plastic stretching) when the energy is transformed to heat energy.

Body harness securing-bars (referred to as “breaking-bars” from herein after) that break at the end of the free fall while absorbing some of the impact energy.

It is of major importance that a person utilizing a controlled descend apparatus be safely and un-harmfully secured to the apparatus. In an embodiment of the present invention an easy to wear shoulder-and-feet, personally-adjustable, harness is employed. The harness prevents excessive pressure on various part of the body of the user while being convenient to wear and safe from slipping out of.

WO 2005/094181 (also published as US 2007/0261921, to Gal and Tavori) incorporated herein by reference describes an apparatus-for-controlled-descent having two energy transfer mechanisms that brake the rotational motion of the reel and convert the energy of the falling person into heat and dissipate that heat: a static mechanism that is based on friction of the cable on a drum and a dynamic mechanism based on friction exerting arms, that are coupled to the reel on which the cable is wound, and interact with the drum, affected by centrifugal forces, thus balancing the speed of descent. In an embodiment of the present invention the cable releasing mechanism as described by Gal and Tavori is utilized and in addition the mechanism includes a manually controlled cable-releasing ratchet-mechanism as mentioned above.

Reference is now made to the figures describing embodiments of the present invention. It should be clear that the description of the embodiments and attached Figures set forth in this specification serves only for a better understanding of the invention, without limiting its scope.

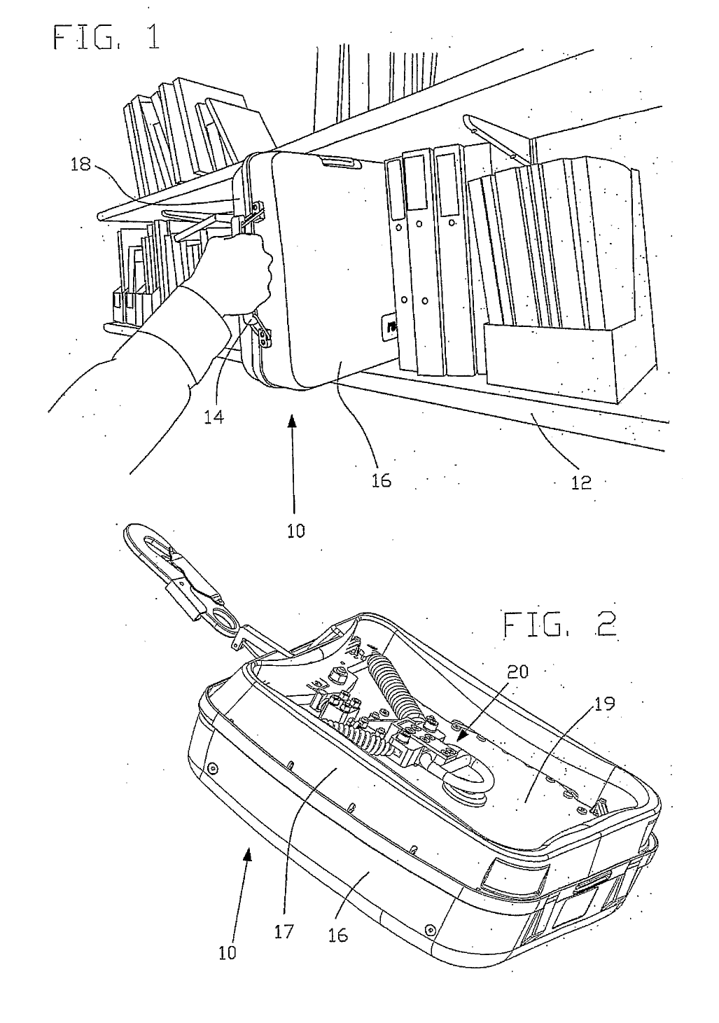

FIG. 1 is an isometric illustration of an encased portable apparatus-for-controlled-descent 10 in accordance with an embodiment of the present invention, being removed from a shelf 12. The Figure demonstrates the compactness of the apparatus as well as the ease in which it can be stored amongst ordinary items put on office shelves without upsetting the esthetical harmony of the office. The apparatus is pulled from shelf 12 by a carrying-handle 14 which is connected to an encasing-box 16 closed by a lid 18.

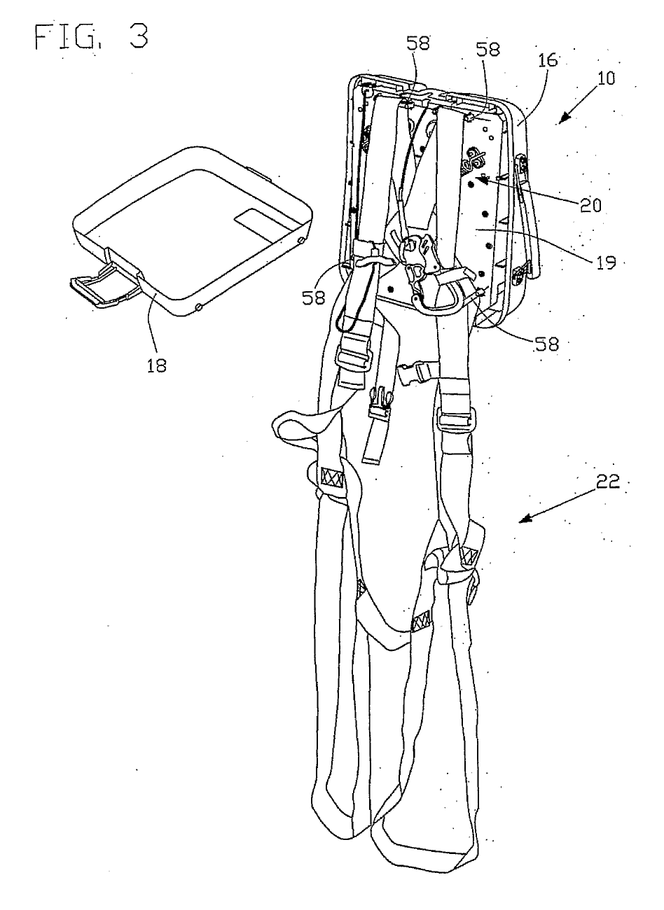

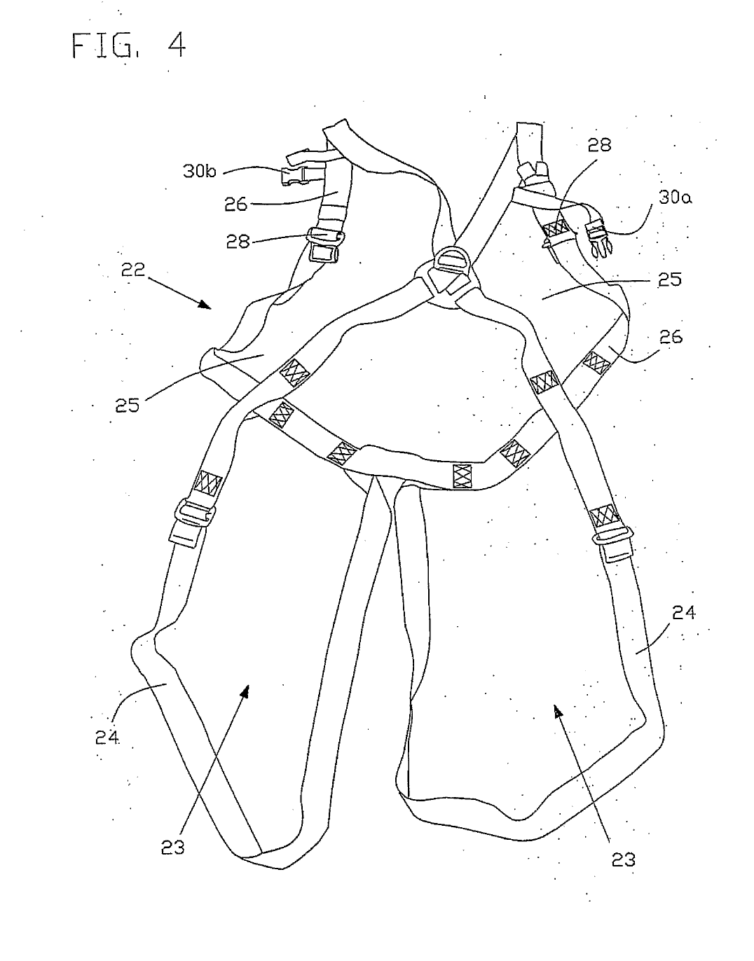

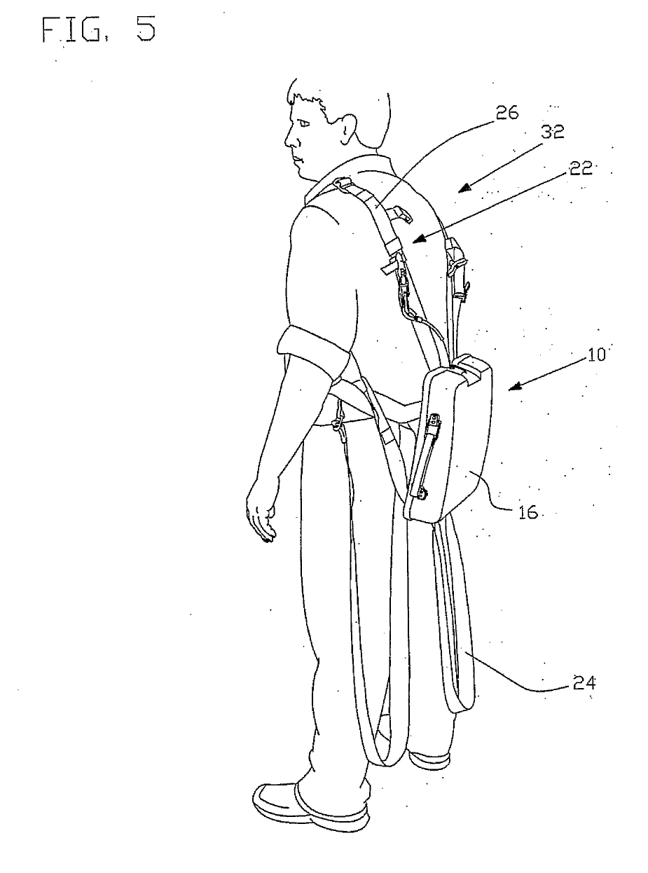

The apparatus-for-controlled-descent in accordance with the present invention is constructed of three main elements connected to each other: a cable releasing assembly 50, a shock absorbing mechanisms 20 and a harness 22. Each of the elements is separately described in the text that follows. To understand how the apparatus is constructed and how the three main elements connect FIG. 2, FIG. 3 and FIG. 14 should be view in sequence. A carrier platform, referred from hereafter as “carrier plate”, designated No. 19 inside encasing-box 16, is connected to shock absorbing mechanism 20. The mechanism is connected to the side facing the back of the user of apparatus 10 (illustrated in FIG. 5) and is covered by folded harness 22 when apparatus 10 is stored. On its other side carrier-plate 19 is connected to cable releasing assembly 50.

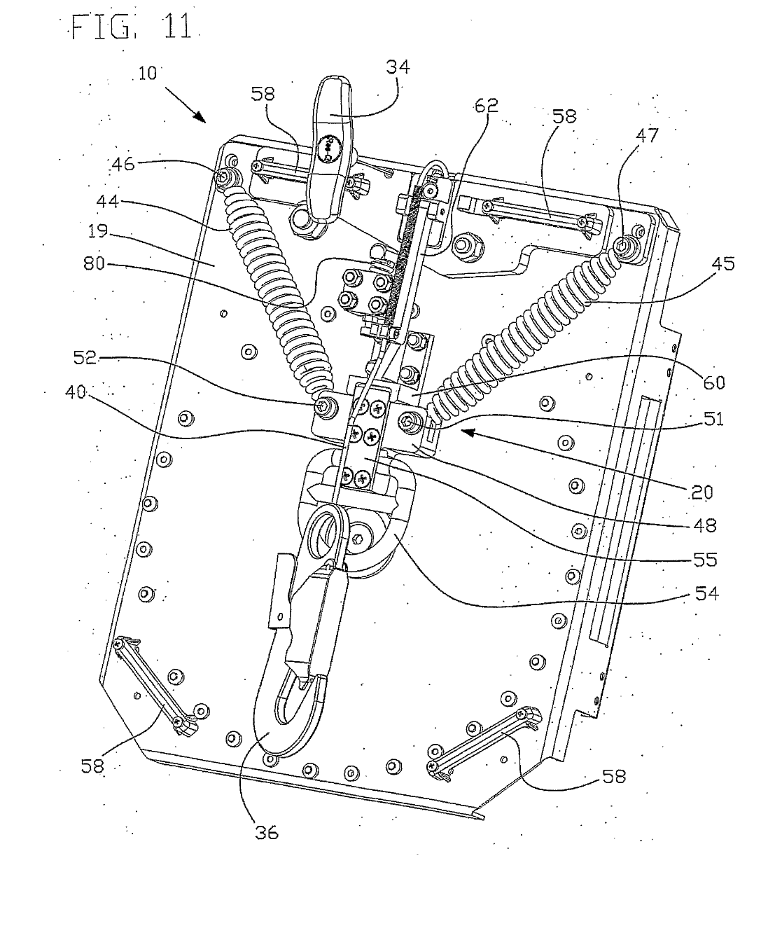

FIG. 2 is an isomeric illustration of apparatus 10 with lid 18 removed and a heat-isolating-protruding-rim 17 shown surrounding carrier-plate 19 of the apparatus. The Figure illustrates the connection of shock-absorbing mechanism 20 to plate 19. The construction and use of shock-absorbing mechanism 20 is clarified in FIG. 11 and FIG. 12. The harness 22 and its connection to plate 19 are illustrated in FIG. 3. Heat-isolating-protruding-rim 17 is an optional addition to apparatus 10. Protruding rim 17 is made of a soft and flexible material such as sponge-fabric or hardened plastic-foam and is meant to soften the contact between the back of the wearer of the apparatus-for-controlled-descent 10 and carrier-plate 19 of the apparatus. In addition, the gap between the wearer and carrier-plate 19 caused by protruding rim 17 helps to dissipate the friction heat generated by the cable releasing assembly, thus protecting the user of apparatus 10 from back burns.

FIG. 3 is an illustration of apparatus 10 with the lid 18 opened and discarded. The Figure shows carrier-plate 19 with body harness 22 attached by ‘break-bars” 58 to the plate at four points near the coroners of the plate. The harness in the Figure covers shock-absorbing mechanism 20, shown in FIG. 2. The design and operation of break-bars 58 and of shock-absorbing mechanism 20 are explained in details in FIGS. 11 and 12.

FIG. 4 is an illustration of the harness 22. Harness 22 is made of straps of strong and flexible fabric forming a pair leg-supporting strap-loops 23 (the straps of strap-loops 23 are referred from hereinafter as “straps 24”) connected to a pair of arm-supporting strap-loops 25 (the straps of strap-loops 25 are referred from hereinafter as “straps 26”). The strap-loops are fastened and firmly tighten to the body of the person wearing the harness by pull-buckles 28. A snap-buckle 30 (made of “a male” and “a female” connecting units, 30a and 30b, respectively) connects and secures together arm-supporting strap 26 at the chest area of the wearer. FIGS. 5, 6, 7, and 9 that follow illustrate a person wearing and securing harness 22 in preparation for descending from a high floor with the apparatus-for-controlled-descent 10.

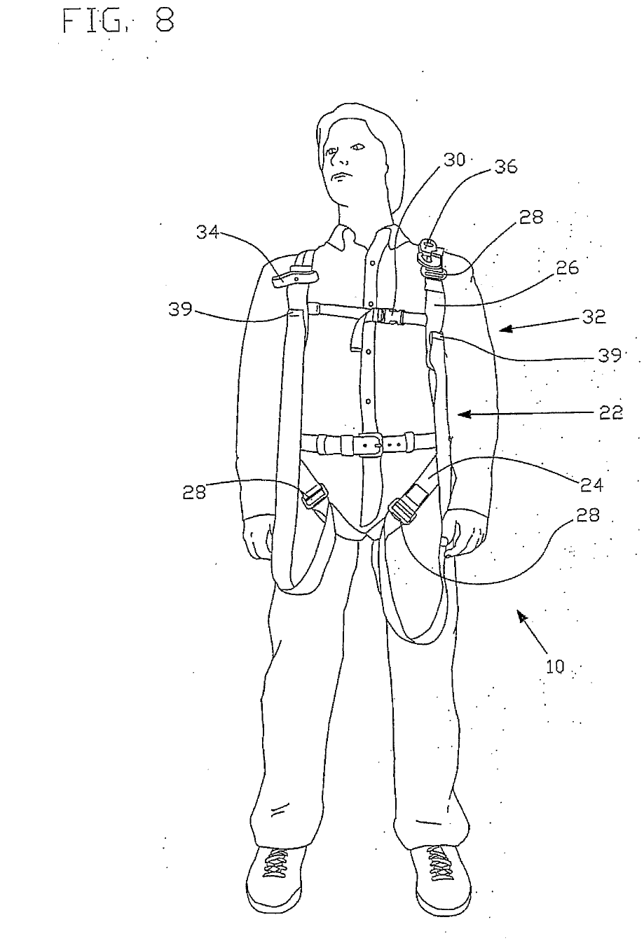

FIG. 5 is an illustration of a person 32 shown from the back, wearing harness 22 (shown in FIG. 4) of the apparatus-for-controlled-descent 10 with the arm-supporting straps 26 placed loosely over his shoulders and the leg-supporting straps 24 hanging freely from carrier-plate 19 (illustrated in FIG. 3). The substantially long loops of leg-supporting straps 24 are designed to enable easy wearing (entering) of the feet into loops 23. The tightening of the loops and the fastening of the surplus leg-supporting straps 24 to harness 22 is shown in FIG. 8. With straps 26 not fastened and snap-buckle 30 not closed, encasing-box 16 of apparatus 10 is shown positioned on the lower-back of person 32.

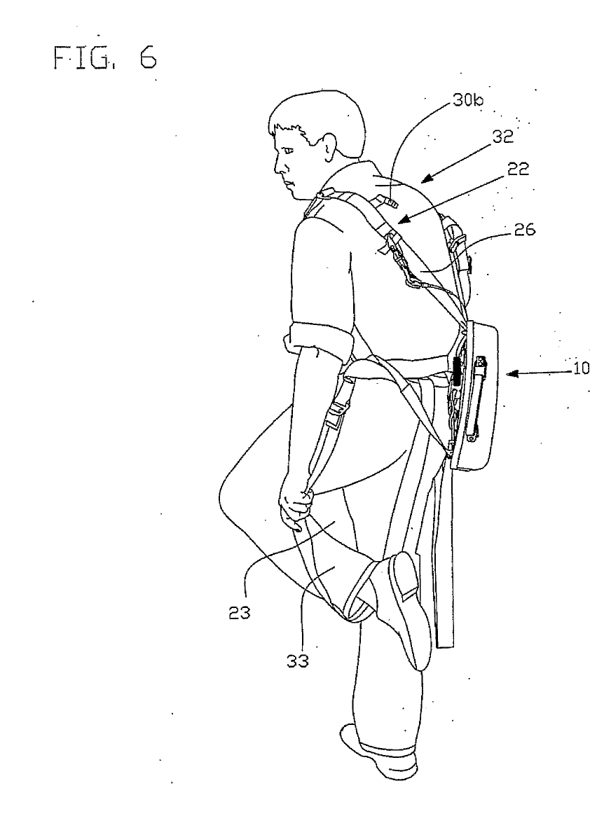

FIG. 6 is an illustration of the continuation of the process of wearing harness 22 (shown in FIG. 2) shown in FIG. 5. Person 32 wearing harness 22 is shown putting his left foot 33 into leg-support strap loops 23.

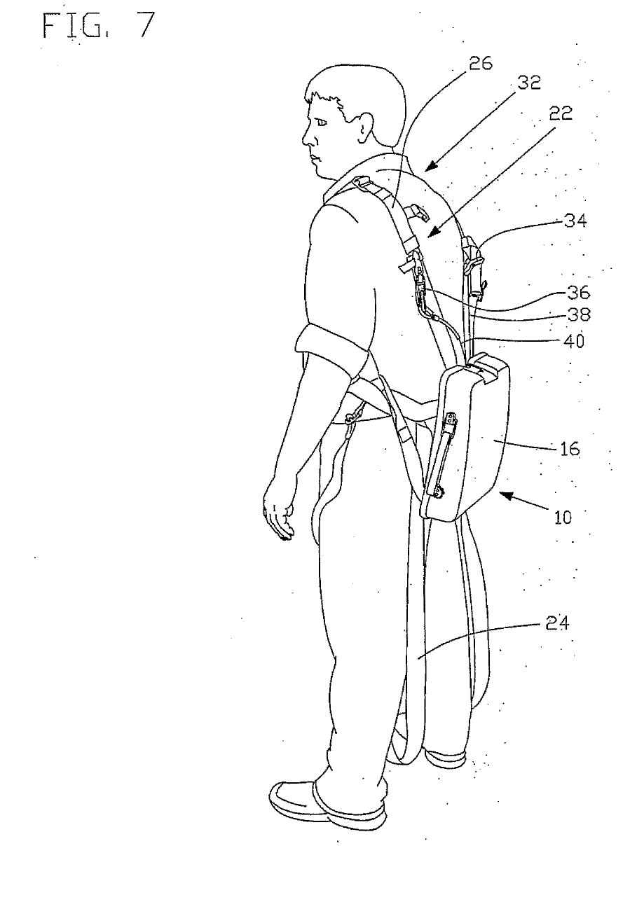

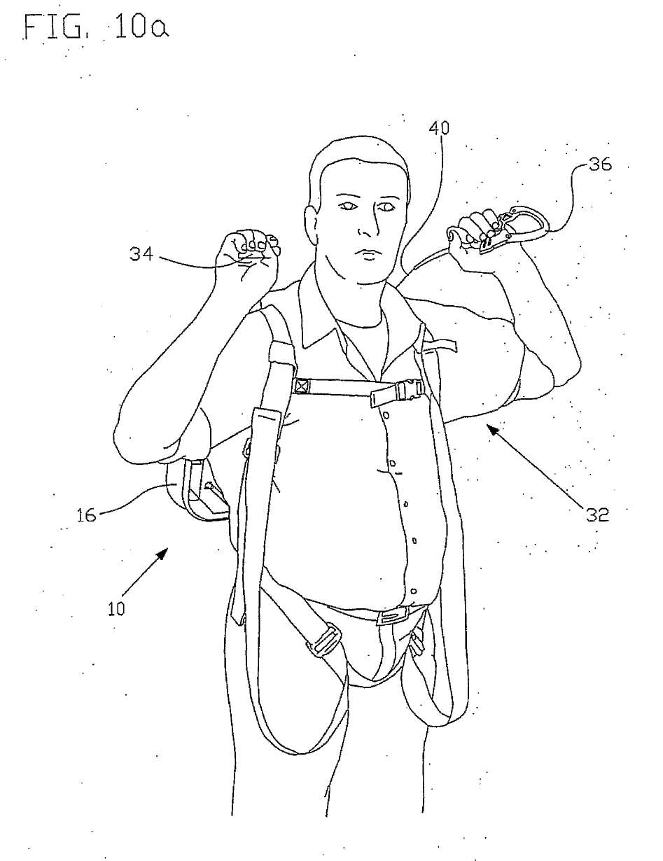

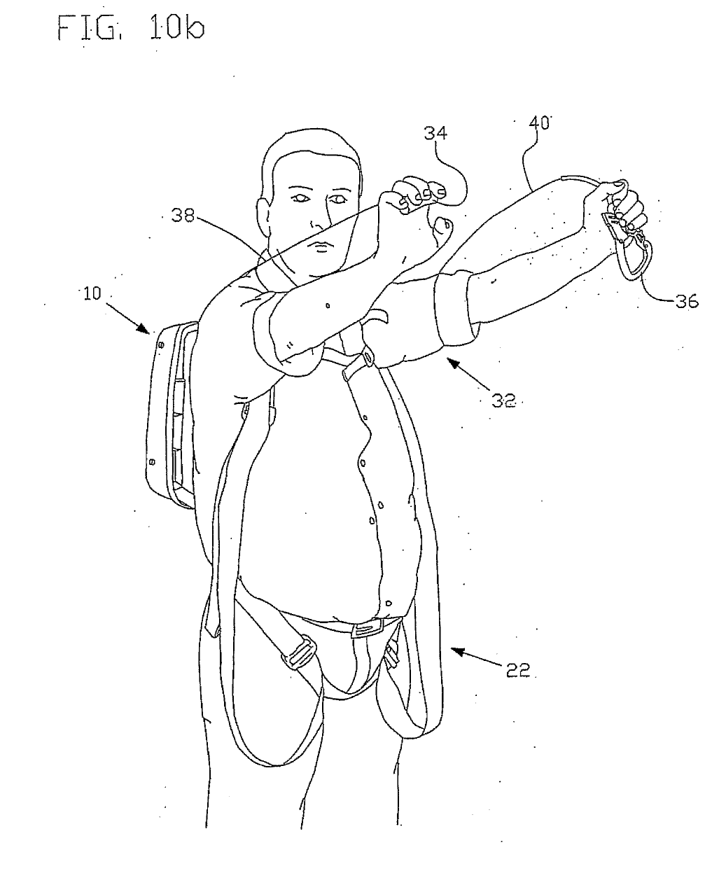

FIG. 7 is an illustration of the continuation of the process of wearing harness 22 shown in FIG. 6. Person 32 has arm-supporting straps 26 over his shoulders and feet-supporting straps 24 around his feet ready to fasten the harness to his body. Shown in the Figure are a handle-for-cable-extension 34 reversibly connected to the right side arm-supporting strap 26 and an anchoring-hook 36, reversibly connected to the left side arm-supporting strap 26. Handel 34 and hook 36 are individually connected by cables 38 and 40 (respectively) to a controlled cable releasing mechanism inside encasing box 16. Handel 34, hook 36 and cables 38 and 40 are better seen in FIGS. 10a and 10b.

FIG. 8 is an illustration from the front of person 32 wearing the apparatus-for-controlled-descent 10 with harness 22 fastened to the body. Feet-supporting straps 24 have been fastened by pulling through pull-buckles 28 and the surplus of the straps are shown connected to the arm-supporting straps 26 by sewed-on “hook-and-loop” fasteners 39. The arm-support straps have been fastened by pulling through pull-buckles 28 and connecting the female connecting units 30a and 30b of snap-buckle 30. When harness 22 is fastened, encasing-box 16 of apparatus 10 is positioned on the upper-back of person 32 (shown in FIG. 10b) and the handle-for-cable-extension 34 and anchoring-hook 36 are positioned over the frontal upper part of the shoulder blades of person 32, in easy reach of both hands of the person.

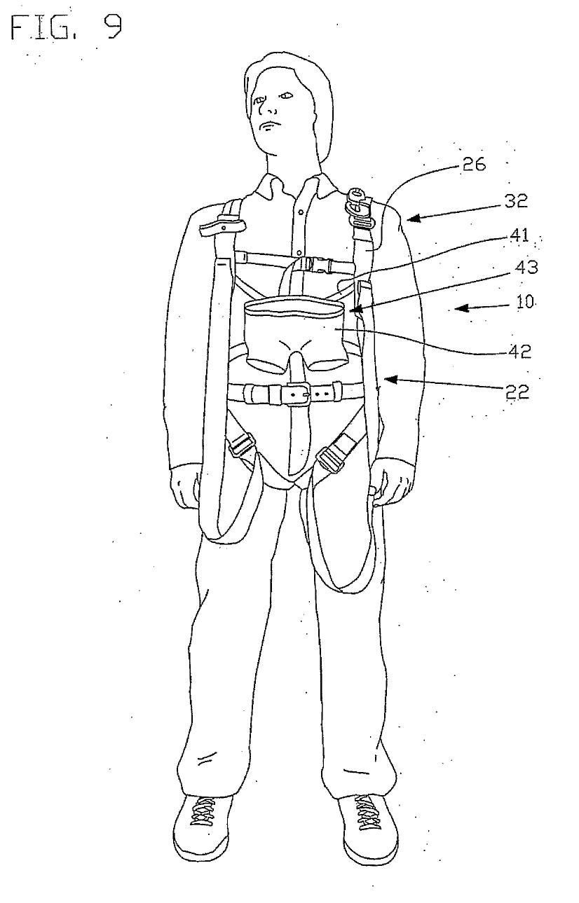

FIG. 9 is an illustration from the front of person 32 wearing the apparatus-for-controlled-descent 10 shown in FIG. 8 and having a baby carrying-device 43 connected to the harness 22. Baby carrying-device 43, which is an optional addition to the harness, is made of a child-fitting trousers 42 connected to the arm-strap 26 on both sides of the trousers by support-straps 41. The baby carrying-device 43 provides a safe and easy solution to the difficulty faced when an emergency evacuation of small children from high building is required. Device 43 enables a grown person to simultaneously comfort a child in distress and attend to the necessities in the procedure of lowering from a building utilizing apparatus-for-controlled-descent 10.

FIGS. 10a and 10b are illustrations showing how apparatus-for-controlled-descent 10 is put into use. In order to release just the right length of free cable 40 when starting the descent and thus minimizing the impact of the initial fall and yet, allowing enough free cable to safely connect cable 40 to a stable and fixed structure utilizing anchoring-hook 36, handle-for-cable-extension 34 is used.

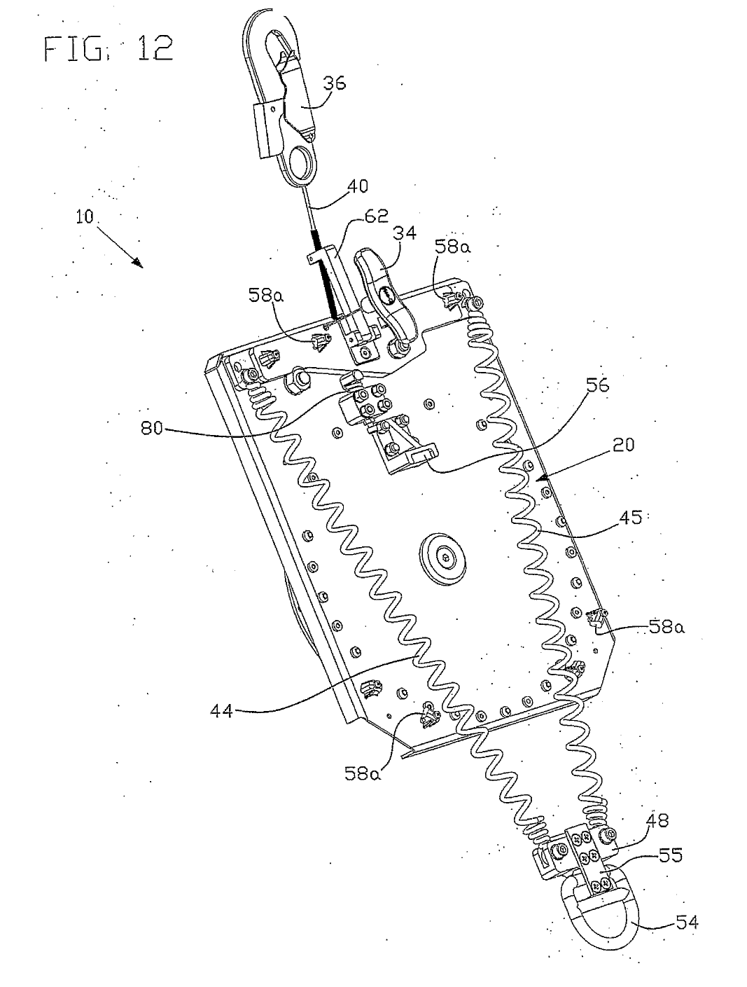

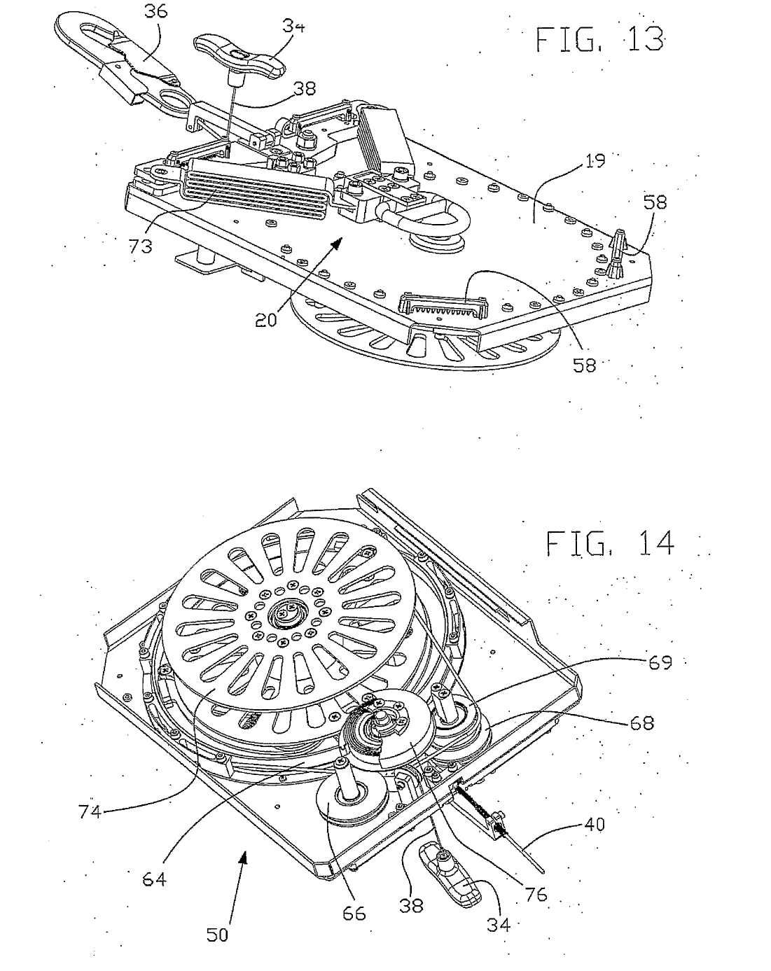

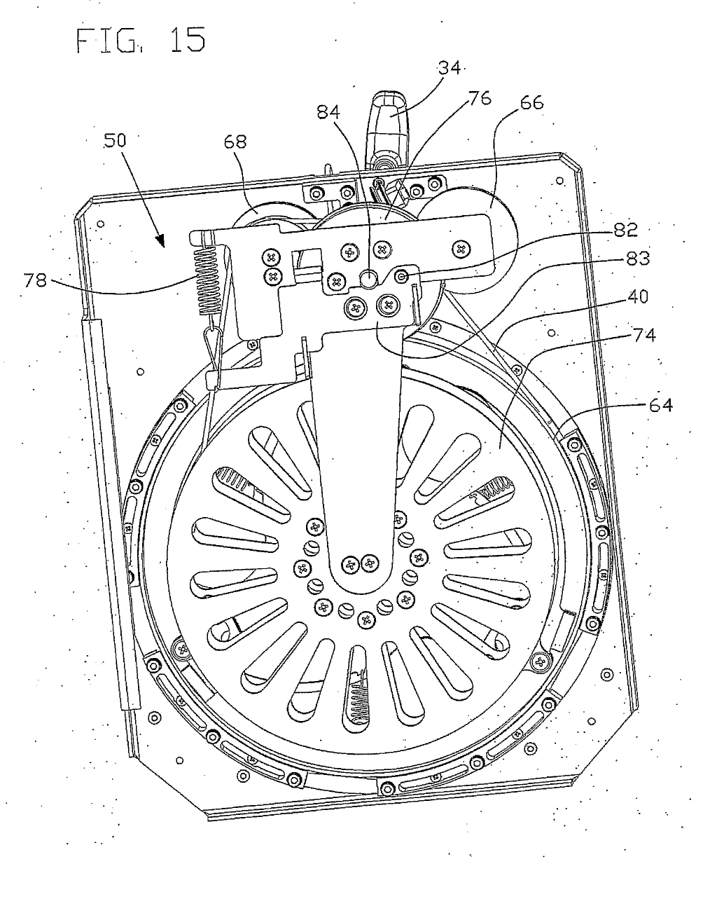

FIG. 10a illustrates person 32 ready to pull cable extension handle 34 and simultaneously to pull anchoring-hook 36. Every pull of handle 34 causes cable 38 to activate a ratchet mechanism (illustrated in FIG. 15) in the cable releasing assembly of apparatus 10 (designated No. 50, shown in FIG. 13) and to enable the release a predetermined length of cable 40.

FIG. 10b illustrates person 32 in the process of pulling handle 34 and anchoring-hook 36, as was previously explained. Cable 40 is shown to be extended to an arm's length of person 32. Another pull of handle 34 (after the handle has been retracted back by a ratchet mechanism) enables further extension of cable 40. Repeated pulls are carried out until a desired cable length is released.

FIGS. 11 and 12 illustrate carrier-plate 19 of apparatus-for-controlled-descent 10 shown in FIG. 3, without harness 22. While FIG. 11 shows the shock-absorbing spring mechanism 20 in a relaxed state and cable 40 folded and rolled, FIG. 12 shows shock-absorbing spring mechanism 20 in a stretched state and cable 40 deployed for descending. Shock-absorbing springs mechanism 20 is made of two elastic coiled spring elements, 44 and 45, each of the springs connected at one end to an upper-side coroner of plate 19 by a pin, 46 and 47, respectively. At their other end springs 44 and 45 are connected by pins 51 and 52, respectively, to a “bridging bar” 48 that connects the springs together. Bridging bar 48 connects to a ring 54 by bar 55 that connects to the arm-support straps of harness 22 (not shown in the Figure). When springs 44 and 45 are in a relaxed state, bridging-bar 48 is (also) in contact with stabilizing-bar 60 which is, in turn, connected to the approximate center of plate 19. As long as harness 22 has is not utilized for descending the straps of the harness are inserted and wrapped around break-bars 58, as illustrated in FIG. 3. In other embodiments of apparatus 10 one elastic spring element or several spring elements can be used.

FIG. 11 illustrates the state of carrier-plate 19 of apparatus-for-controlled-descent 10 when the apparatus is in storage in readiness to be deployed. Springs 44 and 45 are relaxed and bridging-bar 48 in contact with stabilizing bar 60, preventing the free movement of bar 48 under lid 18 (as illustrated in FIG. 2). Illustrated in the Figure is anchoring-hook 36, connected to cable 40, with the cable folded inwards, towards plate 19. Cable 40, which is stored in the cable releasing mechanical assembly (illustrated in FIG. 14, designated No. 50) is stabilized and kept in its folded position by being connected to bar 62 which is pivotally connected to plate 19.

FIG. 12 illustrates the state of carrier-plate 19 of apparatus-for-controlled-descent 10 when the apparatus is in a deployed state. The shock-absorbing springs 44 and 45 are illustrated in a stretched state and cable 40 drawn from the apparatus with bar 62 protruding from plate 19. The sequence of events that lead to the state illustrated in this figure is detailed hereinafter:

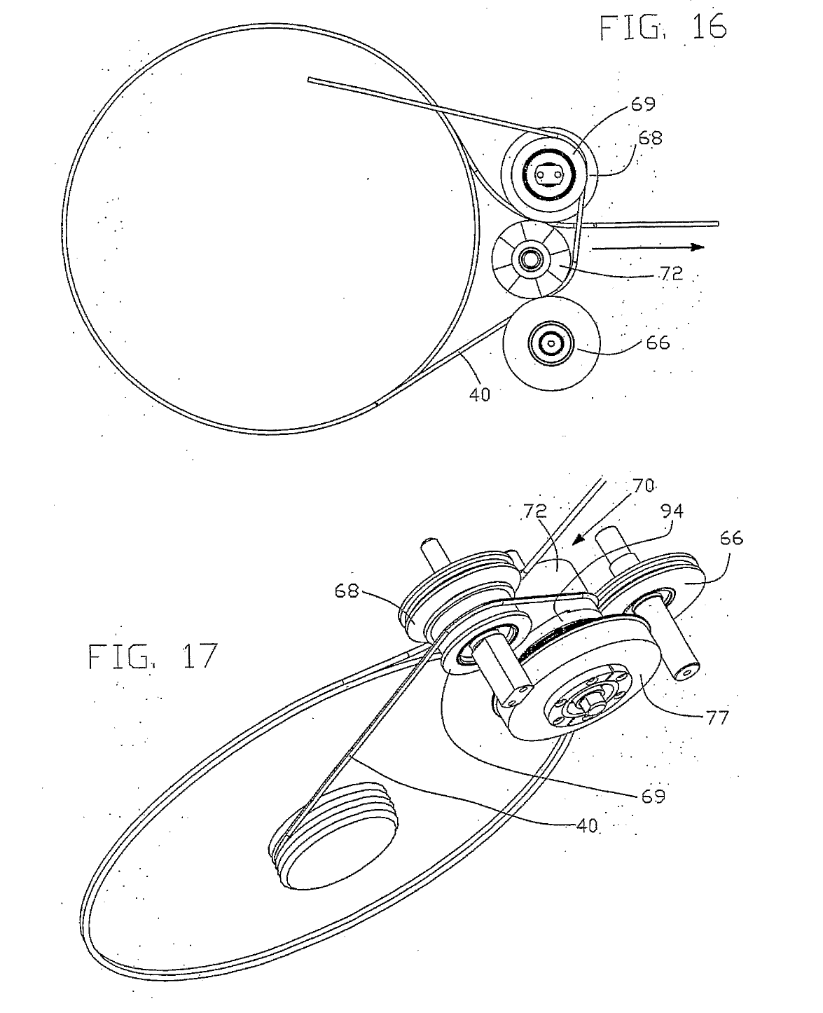

Lid 18 is removed (as shown in FIGS. 2 and 3) and harness 22 worn and fastened (as shown in FIGS. 5 to 10a). Handle-for-cable-extension 34 is pulled (FIG. 10b) enabling the controlled release of cable 40 by a ratchet mechanism 70 (explained in FIG. 16 and FIG. 17). Anchoring-hook 36, at the distal end of cable 40, is secured to an anchoring point. The anchoring point has to be able to support the weight of a descending person. Person 32 (of FIG. 10b) is now ready to exit the window of the building he has to evacuate. In letting go of the support of the window sill (or of any other support platform from the building) person 32 starts a fall that is instantaneously stopped by the full stretching of cable 40. Assembly 50 (FIG. 13) prevents the continuation of the fall, and ratchet mechanism 70 insures that as little length of cable as possible is available for the fall. The impact of the stopping causes the stretching of the straps of harness 22 and the breaking of breaking-bars 58 (designated in the broken form 58a in FIG. 12). The breaking of the bars absorbs some of the impact energy. The impact pulls harness 22 downwards causing ring 54 to dislodge bar 48 from bar 56 and to springs 44 and 45 to stretch and transform the impact energy to emitted heat. The stretching of the springs in elastic and plastic deformation absorbs most of the impact energy and, together with the energy absorbed by break-bars 58 a jolting shock is prevented.

FIG. 13 is an illustration of on embodiment of carrier-plate 19 of apparatus-for-controlled-descent 10 with shock-absorbing fabric-rip elements 73 (and without harness 22). The shock-absorbing fabric-rip elements in the embodiment replace the shock absorbing springs 44 and 45, in shock-absorbing mechanism 20, shown in FIG. 12. Each shock-absorbing fabric-rip element is made of a compacted folded and tightly sewed strong fabric strip. On stopping the fall, as previously described, the impact causes stitches of the folded fabric strips to rip and tear and as the strips unfold the impact energy of the fall is absorbed.

Reference is now made to assembly 50 that provide a controlled release of cable 40 from apparatus-for-controlled-descent 10. Elements of assembly 50 that control the release of cable 40 have previously been described in WO 2005/094181 (Gal and Tavori).

FIG. 14 is an isometric illustration and FIG. 15 a side-view illustration of the mechanical assembly controlling the release of the cable 40 in the apparatus-for-controlled-descent 10 shown in FIG. 2 and FIG. 3. Assembly 50 is constructed of a cable winding reel 74 and an adjacent static braking friction-drum 64 having adequate structural strength to maintain its structural integrity when tension is applied to it during descent and by having a low coefficient of heat conduction, thereby causing most of the heat generated by friction between cable 40 and drum 64 during descent to be conducted into cable 40 for dissipation. Cable 40 is characterized by having adequate tension strength to maintain its structural integrity when tension is applied to it during descent and by having a high coefficient of heat conduction for dissipating much of the heat generated by friction between cable 40 and drum 64 during descent into the surrounding air as it plays out behind the descending person. The passage of cable 40 between friction wheels, 66 and 68 and ratchet wheel 72 (illustrated in FIG. 16 and FIG. 17) control the release of cable 40 when descending and the gradual release of cable 40 when handle 34 is pulled for cable anchoring, as explained below.

Illustrated in FIG. 15, ratchet mechanism 70 is pivoted by pivot 84 and is supported by plate 83 that is pivoted by pivot 82. When handle 34 is pulled and cable 38 stretched (illustrated in FIG. 10b), spring 78 draws plate 83 thus widening the gap between wheels, 66 and 68 and ratchet wheel 72. With the gap widened and cable 40 pulled the cable is exposed to a push-pull force around drum 64 resulting in a low friction force around drum 64, thus helping person 32 pull a predetermined length of cable 40 in each pull of handle 34 and cable 38

FIG. 16 is a schematic side-view and FIG. 17 an isometric illustration of the braking mechanism of apparatus 10 which includes ratchet mechanism 70. Ratchet mechanism 70 is constructed of a controlled spinning wheel 72 and a circular-spring wheel 77 that limits the rotational motion and returns sprocket wheel 94 to a resting position after it has been spun and released. As illustrated in FIG. 16, wheel 72 is held in a tight position between wheels 66 and 68. The position is kept by a pushing spring 80 and spring 78 that connects to plate 83, as shown in FIG. 11, FIG. 12 and FIG. 15. The two springs push pivot 84 and wheel 72 between wheels 66 and 69 in a multiple force due to the sharp angle between the wheels. Cable 40 release-path (and braking mechanism) is illustrated in FIG. 17: cable 40 is spun from cable reel wheel 74 rolls half way around wheel 69 half way around ratchet wheel 72 and enters a gap between wheel 72 and wheel 66 on its way to encircle the rim of static friction drum 64. When completing the encircling of drum 64 cable 40 passes in a gap between wheel 68 and wheel 72 and is released from apparatus 10. The sharp angles of the passages of cable 40 between the gaps and the friction caused by springs 78 and 80, pushing on wheel 72, impose a strong restriction force on the release of cable 40. The restrictive force is enhanced by the friction imposed by static drum 64 on the cable, as previously described. Wheels 68 and 69 share the same axis but turn in opposite directions. As seen in FIG. 17, wheel 68 is substantially wider than wheel 69. Wheels 66, 68 and 72 operate in tandem, pulling a portion of the cable from the drum while pushing another portion of the cable towards the drum, thus overcoming friction between the cable and the drum.

It should also be clear that a person skilled in the art, after reading the present specification could make adjustments or amendments to the attached Figures and above described embodiments that would still be covered by the present invention.

1. An apparatus for facilitating a controlled descent of a body, the apparatus comprising:
a rotatable reel around which a portion of a cable is wound, a first end of the cable secured to the reel and a second end of the cable free;
a friction drum around which a portion of the cable, is wound;
a carrier on which the reel and the drum are mounted;
braking mechanism for braking rotational motion of the reel and for balancing descending speed of the body;
a harness, for harnessing the device to the body;
damping mechanism for damping the initial impact.

2. The apparatus as claimed in claim 1, wherein the damping mechanism comprises at least one elastic spring element a first end of which is coupled to the carrier and a second end of which is coupled to the harness.

3. The damping mechanism as claimed in claim 2, wherein the damping mechanism comprises at least one elastic spring element capable of stretching on impact.

4. The apparatus as claimed in claim 1, wherein the damping mechanism comprises at least one fabric rip element made of a folded and tightly compacted fabric strip, a first end of which is coupled to the carrier and a second end of which is coupled to the harness.

5. The damping mechanism as claimed in claim 4, wherein the fabric rip element comprises stitches that rip upon impact above a predetermined threshold.

6. The damping mechanism as claimed in claim 4, wherein the fabric rip element comprises sections of fabric strip glued together and wherein at least some of the glued sections rip on impact above a predetermined threshold.

7. The apparatus as claimed in claim 1, wherein the harness is connected to the carrier in a breakable connection that breaks under initial impact inflicted on the body when beginning descent.

8. The apparatus as claimed in claim 7, wherein the breakable connection comprises break-bars.

9. The apparatus as claimed in claim 7, wherein the harness comprises straps firmly harnessing the body of the user of the apparatus.

10. The apparatus as claimed in claim 7, wherein the harness comprises a device for harnessing the body and a baby carrying device.

11. The apparatus as claimed in claim 1, further provided with a cable dispensing mechanism for dispensing a controlled length of the cable from the apparatus.

12. The apparatus as claimed in claim 11, wherein the dispensing mechanism comprises wheels operating in tandem which pull a portion of the cable from the drum while pushing another portion of the cable towards the drum, thus overcoming friction between the cable and the drum.

13. The apparatus as claimed in claim 12, wherein the cable dispensing mechanism comprises a ratchet mechanism allowing the cable to be dispensed outwardly only.

14. The ratchet mechanism as claimed in claim 13, wherein the ratchet mechanism comprises a circular spring wheel and a cable reel wheel, adapted to acquire the rotational movement of the cable reel wheel controlled by the circular spring wheel.

15. The apparatus for facilitating a controlled descent of a body as claimed in claim 1, encased in a portable encasing.

16. The encasing of the apparatus for facilitating a controlled descent of a body as claimed in claim 15, wherein the encasing comprises an encasing box and a removable lid.
